(19) United States
(12) Patent Application Publication
(10) Pub. No.: US 2022/0161296 A1
(43) Pub. Date: May 26, 2022

(54) Adjustable bucket sieve device

(71) Applicant: Charles MacGowan, Miami, FL (US)

(72) Inventor: Charles MacGowan, Miami, FL (US)

(21) Appl. No.: 17/671,434

(22) Filed: Feb. 14, 2022

(51) Int. Cl. B07B 1/28; B07B 1/46

(52) U.S. Cl. CPC B07B 1/28; B07B 2201/02; B07B 1/46

(57) ABSTRACT

The present invention relates to a portable and removable vibration sieving apparatus that sorts plant extract and the like according to size, and more particularly, to a sieving apparatus using motorized vibration that is suitable for sorting plant extracts or other particles.

### FIELD OF THE INVENTION

The present invention relates to a vibration sieving apparatus that sorts particles and the like according to size, and more particularly, to a sieving apparatus using motorized vibration that is suitable for sorting plant extract.

### BACKGROUND OF THE INVENTION

For medicinal purposes, usage of medicinal plant/herb involves separation of desired plant or herb components from an entire plant followed by manual or mechanical sifting of the extract to obtain the refined plant component, such as. Manual devices used include sieves, screens, or mesh cloth. All such devices are functionally simple and are widely applied, though complete separation is not achievable. There also exist mechanical devices that separate plant components with greater precision from plants with vigorous vibration. These mechanical devices separate plant components using vibratory separation. This vibratory separation is achieved with a single filter screen through multiple siftings. Further refining and sifting of plant components are sometimes needed to obtain a more purified product. Such devices are complicated, expensive, time-consuming, and messy, requiring extensive cleanup thereby inducing inefficiency in the system.

Further, several other mechanical devices utilize more than one screen for sifting. There are still other mechanical devices that contain multiple decks that utilize vibration for sifting; however, these devices are expensive and not meant for portable use. These mechanical devices utilize significant time, cost, and energy to obtain a sifted plant component. Indeed, the demand for an inexpensive device and method to more efficiently sift, separate, and refine the desired plant component is desired.

Several inventions in line with the discussed aspects are in existence.

US20160250653 titled, “Vibrating sieving apparatus” provides a vibrating sieving apparatus and a real-time powder sieving system. The apparatus includes a powder pump assembly connected to a vibrating device through a powder suction tube wherein the vibrating device (120) is configured for real-time sieving of powder just before spraying. The apparatus further includes a housing (130) connected to the vibrating device (120) wherein the housing (130) includes a sieve section (140) and an anti-blinding section.

EP2987563B1 titled, “Vibratory sieving machine” relates to a vibratory sieving machine comprising a vibration generating apparatus, and more particularly to a vibratory sieving machine comprising a vibration generating apparatus having two rotary shafts each provided with an eccentric spindle disposed parallel to each other.

U.S. Pat. No. 10,322,426 “Vibrating sieving apparatus and a system for real-time sieving” provides a vibrating sieving apparatus and a real-time powder sieving system. The apparatus includes a powder pump assembly connected to a vibrating device through a powder suction tube wherein the vibrating device (120) is configured for real-time sieving of powder just before spraying. The apparatus further includes a housing (130) connected to the vibrating device (120) wherein the housing (130) includes a sieve section (140) and an anti-blinding section (135).

In all these inventions, dealing with vibratory mechanisms entails several disadvantages, as highlighted above, which the present invention tries to minimize through the induction of several improved techniques.

### SUMMARY OF THE INVENTION

An object of the present invention is to provide a sieving device using vibration that is less likely to cause clogging in the sieving bag.

Embodiments of the present invention solve the need for a portable, cost-effective, time and energy-efficient method and device for sifting, separating, and refining botanical trichomes from a plant or herb.

An object of the invention is a portable apparatus that provides an effective and portable method of sifting and separating a botanical component utilizing vibratory motion.

In a further aspect, there is disclosed an apparatus for sifting plant components according to an embodiment of the present invention in which the apparatus sifts plant components by applying vibration motion to sifting particles through the improved sieve vibrator device.

An object of the present invention is to provide a sieving device using vibration that is less likely to cause clogging in the sieving screen.

A still further aspect of the invention is to provide an improved sieve vibrator device that is flexible and which can be configured with variable opening sizes of containers.

According to the present invention, clogging of the sieve screen is prevented, so that the stable operation of the sieve device is improved and the labor of maintenance is reduced.

These and other aspects of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention but are merely illustrative.

FIG. 1 represents the perspective view of one of the existing prior art.

FIG. 2 represents the perspective view of another prior art which is commonly used

FIG. 3 is an assembled perspective view of the sieve vibrator for sorting of particles of the present invention.

FIG. 4 is a disassembled perspective view of the sieve vibrator for sorting of particles of the present invention.

FIG. 5 is a first embodiment of the present invention wherein the motor is an electric motor, and the fig. depicts the perspective view of the electric motor attached to the circular frame from the top.

FIG. 6 is a perspective view of FIG. 5 from below.

FIG. 7 is a second embodiment of the present invention wherein the motor is a pneumatic motor, and the FIG. 8 depicts the perspective view of the pneumatic motor attachment to the circular frame from the top.

FIG. 8 is a perspective view of FIG. 7 from below.

FIG. 9 is a perspective view of the present invention representing the container, the pneumatic motor, and the mesh screen attached to the container.

### REFERENCE NUMERALS

100 Sieve vibrator device
10 Metal Sheet Ring
20 Metal sheet piece
30 Gasket
40 Latch
50 Vertical plate
60 Opening gap
70 Electric motor
80 Pneumatic motor
90 Outer circumference of the frame

### DETAILED DESCRIPTION OF THE EMBODIMENTS

The description above and below and the drawings of the present document focus on one or more currently preferred embodiments of the present invention and describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

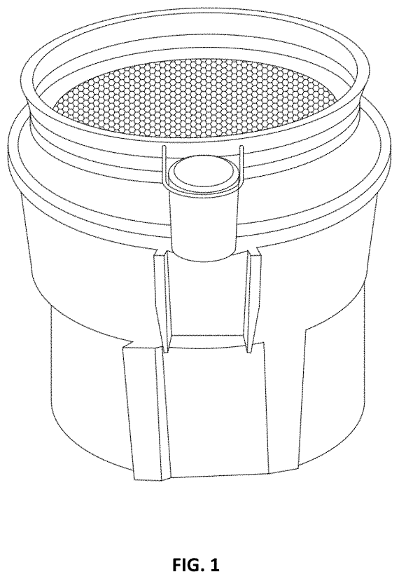

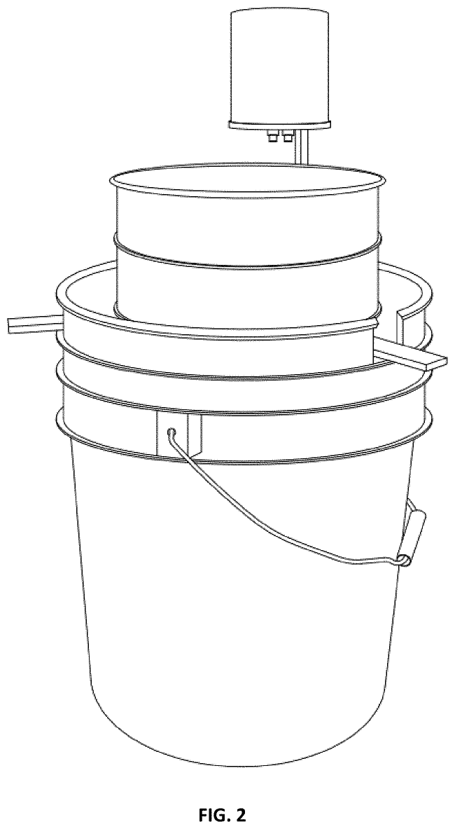

FIGS. 1 and 2 represent prior art. In both these figures, the mesh is attached to a separate pan which is then attached to an agitation device and furthermore to the container. Further in FIG. 2, as depicted, in the bucket or container, an incision is required for fitting the mesh pan and the motor/vibrator assembly. The prior art, therefore, is a bit cumbersome to fit and relies on the use of pans with pre-installed screens.

The present invention, however, is devoid of such a process and is easy and cost-effective to be fitted on any container without requiring any separate mesh pan as well as a specific container size. The user can quickly replace any mesh that may be clogged or damaged, or because a different mesh size is required.

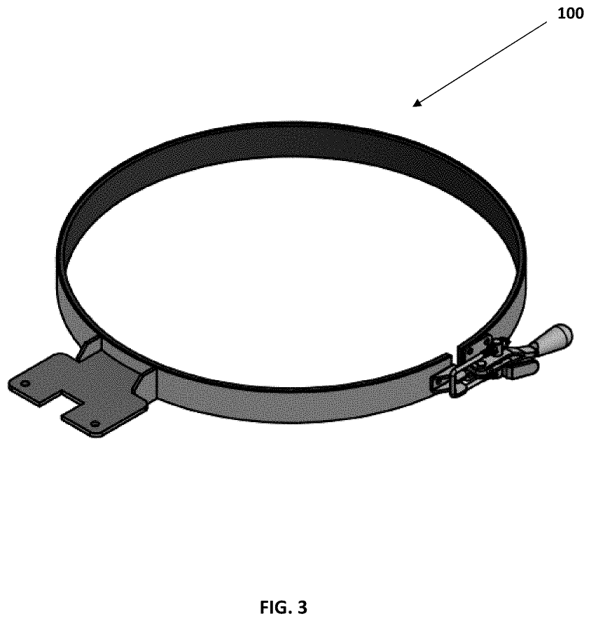

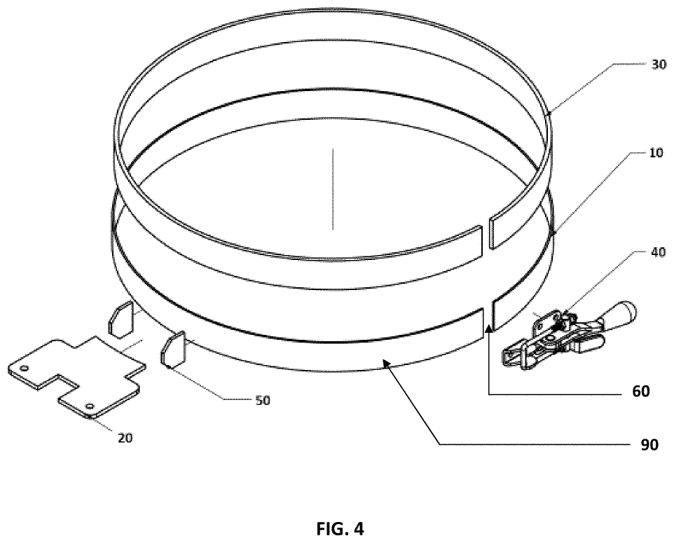

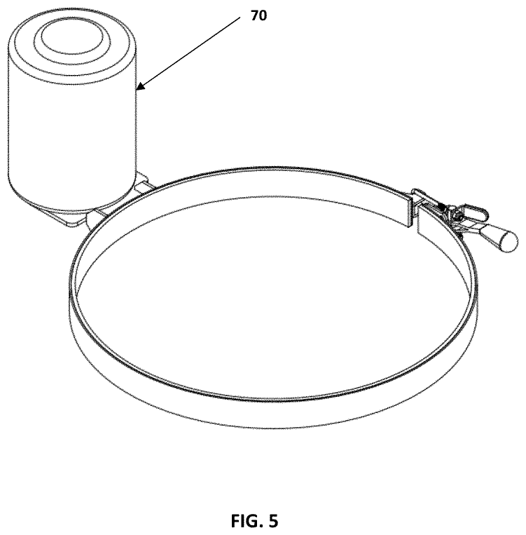

Referring to FIGS. 3-9, the device 100 is equipped with a circular-shaped frame 10 and a corresponding gasket 30 for holding a mesh screen which is held in between the said circular frame 10 and the gasket 30, wherein the gasket 30 is glued to the said frame 10. The clamping means 40 may be a latch as shown in FIG. 1. The latch 40 is fitted to the circular frame 10 at the point of an opening gap 60. The circular frame 10, can be fitted to the opening of a bucket along with a sieve mesh or screen (not shown in the figure) for the purpose of sieving the particle. For accommodating the frame (10) onto ,variable-sized bucket openings, a gap 60 is provided which gives the frame 10 flexibility of accommodating it with variable-sized containers.

The outer circumference (90) of the said circular frame (10), at a distance of quarter half from the latch (40) of the said circular frame, is fitted with a pair of vertical plates (50). A metal sheet plate (20) as shown in FIG. 1 is attached with the said vertical plates (50). These together form an anchor for an electric motor (70) to be configured with the metal steel frame (10).

For agitating any particle, the motor is powered on which vibrates and transfers the energy to the metal frame (10) which agitates the screen and the material is slowly sieved into the bucket, without any manual intervention.

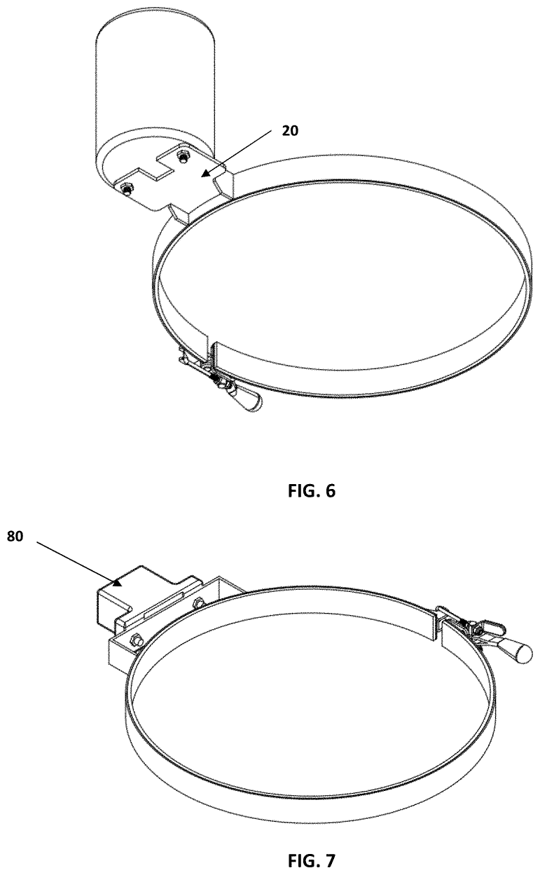

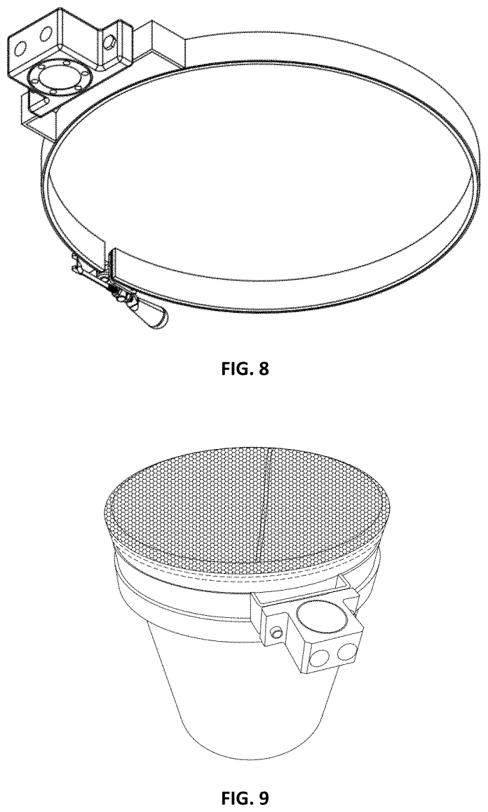

In an embodiment of the present invention, the electric motor may be replaced by a pneumatic motor, as shown in FIGS. 7 and 8.

The present invention also provides a method for sifting plant or herb components, utilizing the device as described, the method comprising:

Opening the latch (40) of the device, thereby releasing the circular frame (10). Inserting a sieve bag between the said circular frame (10) and bucket or other container wherein the gasket (30) and the circular frame (10) are pressed against screen and container and tightened with a clamping means (40). This arrangement is then mounted on a container with a wide opening. The provision of a gap (60) on the circular frame (10), provides flexibility in mounting the vibration device on containers having varied sized openings. In the circular frame (10) after being mounted on the container opening, the latch (30) is closed for fixation. The vibration device having been mounted on the container, the motor is switched on, agitating the container and sifting the plant material without manual intervention.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. An improved vibration sieving device for sorting plant extract and other particles, the device comprising:
a circular-shaped frame;
a gasket;
a clamping means; and
a motor fitted to the circular frame, wherein,
the said clamping means is fitted to the said circular frame at the point of an opening gap on the circular frame; and
characterized in that, the said circular frame is removable, wherein the said frame is placed over a container covered with a loose mesh or screen for agitating the mesh for sieving of particles.

2. The vibration device of claim 1, wherein the said clamping means is a latch.

3. The vibration device of claim 1, wherein the motor is an electric motor.

4. The vibration device of claim 1, wherein the motor is a pneumatic motor.

5. The vibration device of claim 1, wherein, the said gap on the circular frame allows it to be fixed on containers with variable-sized openings.

6. The vibration device of claim 1, wherein, the circular frame is made of metal.
